(19) United States
(12) Patent Application Publication
(10) Pub. No.: US 2020/0112656 A1
(43) Pub. Date: Apr. 9, 2020

(54) Miniature Endoscope

(71) Applicant: Chun-Wei Ho, Taipei City (TW)

(72) Inventor: Chun-Wei Ho, Taipei City (TW)

(21) Appl. No.: 16/621,042

(22) PCT Filed: Sep. 19, 2017
(86) PCT No.: PCT/CN2017/102202

§ 371 Date: Dec. 10, 2019

(30) Foreign Application Priority Data
Aug. 25, 2017 (CN) 201710740455.0

(51) Int. Cl. H04N 5/225; G02B 23/24

(52) U.S. Cl. CPC H04N 5/2252; H04N 5/2253; H04N 5/2254; H04N 2005/2255; G02B 23/2484; G02B 23/2461; G02B 23/2423; H04N 5/2256

(57) ABSTRACT

The present invention is an improved miniature endoscope. The endoscope comprises an electric cable, and an image taking device having a photo sensor electrically connected to the electric cable and a lens to capture the image. The image taking device has an optical sensor with a plurality of self-luminous members formed on the image taking device. A cover with a front wall made of optical transparent material to cover the image taking device and the lens. The self-luminous members can be OLED or can be paints of with fluorescent coating or phosphorescent coating. With the improved structure, the endoscope meets the need of miniaturization, electric energy saving, effective illumination and effective image capturing.

### BACKGROUND OF THE INVENTION

### Field of the Invention

The present invention relates to an endoscope particularly relates to a miniature endoscope.

### Brief Description of the Prior Art

Conventional endoscope for surgery or inspection use, such as the one disclosed in Taiwan Utility Patent M421091, generally comprises a plurality of LED for light source. Because the dimension of LED is relatively large, the diameter of the endoscope is usually larger than 3 mm. Therefore, the patient will feel uncomfortable during the process of inspection with an endoscope. Even more, sometimes, the endoscope is not operable to pass a narrow aperture of the cardia of a stomach.

Other conventional endoscopes may not use LED to result a smaller diameter even less than 2 mm. However, the illumination will not be sufficient so that the resulted image is not clear enough. It is therefore needed to use photo fibers which are piercing into the body to enhance the illumination.

The conventional endoscope will have a front cover to protect the lens of the photo taking device. The cover is usually sealed to the endoscope body by glue and not good enough for water resistance.

### SUMMARY OF THE INVENTION

It is therefore the principle advantage and object of the present invention is to provide an improved miniature endoscope having a minimum diameter and with perfect illumination effect.

Another advantage and object of the present invention is to provide an improved miniature endoscope having a very compact and simple structure with high water resistance.

The most important feature of the present invention is to provide a front cover made of optical transparent material to enhance the photo illumination effect and also to protect the lens of the image taking device. The front cover is tightly sealed to the front portion of the endoscope without any water leakage.

Another important feature of the present invention is to provide a plurality of self-luminous members which will enhance the illumination while images of inspection are taken.

In summary, a miniature endoscope in accordance with the present invention comprises an electric cable, an image taking device has a photo sensor electrically connected to the electric cable and a lens to capture the image, a plurality of self-luminous members attached on the image taking device, and a cover with a front wall made of optical transparent material to cover the image taking device and the lens.

### BRIEF DESCRIPTION OF THE DRAWINGS

Those and other advantages, objectives and features of the miniature endoscope in accordance with the present invention, will become more apparent from the below detailed description of the preferred embodiments with reference the accompanying drawings, wherein:

FIG. 1 is a perspective view of a first embodiment of a miniature endoscope in accordance with the present invention;

FIG. 2 is an exploded view of a first embodiment a miniature endoscope in accordance with the present invention;

FIG. 3 is a sectional view of a first embodiment of a miniature endoscope in accordance to the present invention;

FIG. 4 is a front view of a first embodiment of a miniature endoscope in accordance to the present invention;

FIG. 5 is an exploded view of a second embodiment a miniature endoscope in accordance with the present invention;

FIG. 6 is a sectional view of a second embodiment of a miniature endoscope in accordance to the present invention;

FIG. 7 is a front view of a second embodiment of a miniature endoscope in accordance to the present invention; and

FIG. 8 is a sectional view of a third embodiment a miniature endoscope in accordance with the present invention.

### DETAILED DESCRIPTION OF THE PREFERRED EMBODIMENT

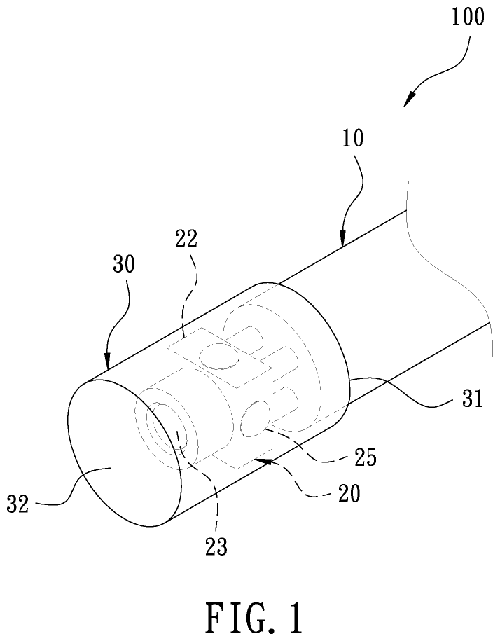

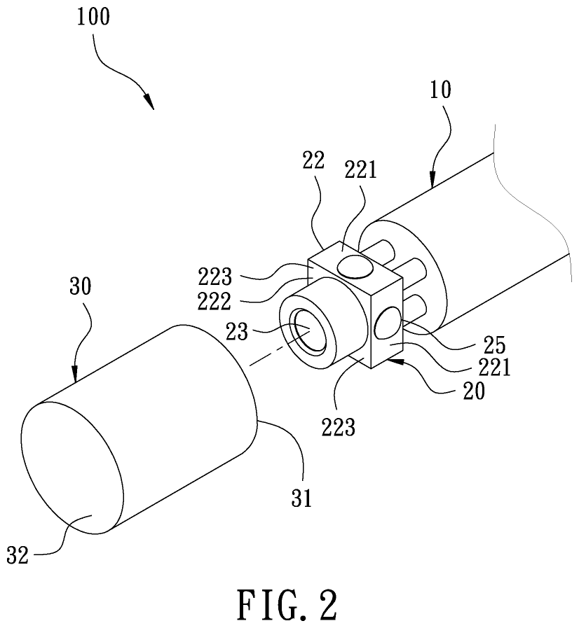

Referring to FIGS. 1 to 3 which show perspective view, exploded perspective view and sectional view of the first embodiment of a miniature endoscope in accordance with the present invention, the endoscope 100 comprises a image taking device 20 equipped in the front portion of an electric cable 10. The image taking device 20 has an optical sensor 22 substantially in a rectangular shape and is electrically connected to the electric cable 10. At front of the optical sensor 22, there is equipped with a lens 23 for capturing the images.

A cover 30 which is substantially in a tubical structure with an open end 31 and a front wall 32 along the axial direction of the cover 30. The open end 31 is secured to the electric cable 10. The cover 30 is made of optical transparent material. The image taking device 20 is enveloped in the cover 30 and the front wall 32 is generally perpendicular to the axial direction of the cover 30 protecting the lens 23.

The optical sensor 22 has a front surface 222 and four side surfaces 221 forming into four edges 223. There are self-luminous members 25 formed on the side surfaces 221 optical sensor 22. The self-luminous members 25 can be substantially in a convex shape and made of OLED having the nature of pixal and forming a light source. These self-luminous members 25 can also be made of suitable material and painted with fluorescent coating or phosphorescent coating.

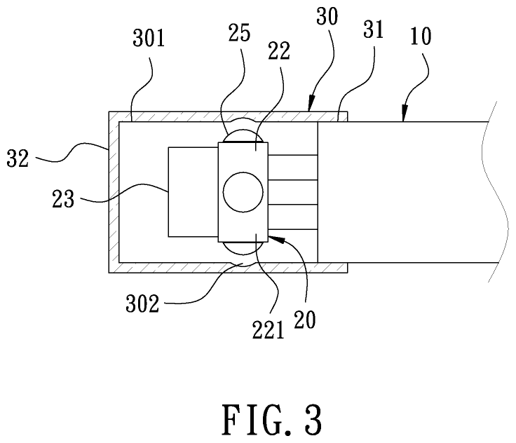

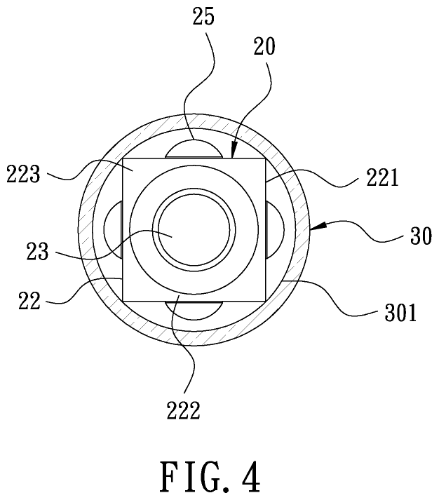

The structure of the cover 30 and the mage taking device 20 can be more clearly seen in FIG. 3 with reference to FIG. 4 which is a front view of the endoscope 100. In corresponding to the position of each of the self-luminous members 25, the inner surface of the cover 301 of the cover 30 formed with a concave recess 302. This concave recess 302 will more effectively concentrate the light generated from the self-luminous member 25 and enhance the effect of illumination of the miniature endoscope 100.

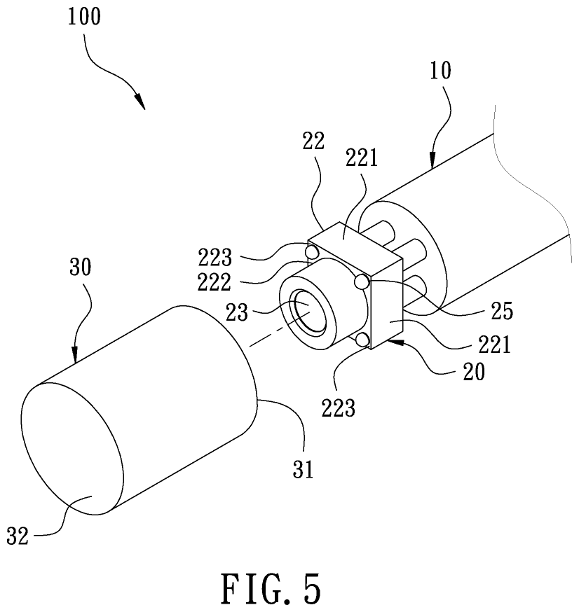

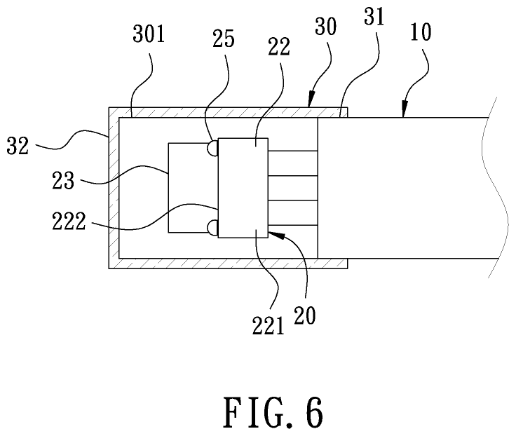

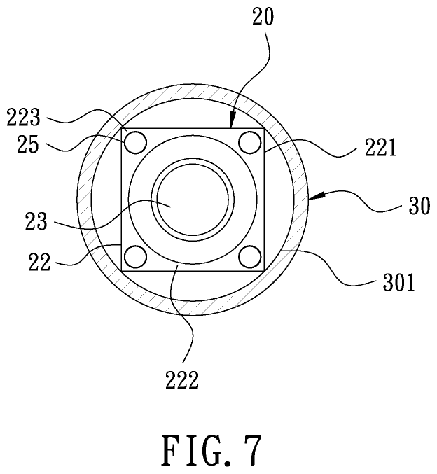

Referring to FIGS. 5 to 7, there are shown the exploded view, sectional view and front view of a second embodiment of a miniature endoscope in accordance with the present invention. The structure of the miniature endoscope in this second embodiment is substantially in the same structure of the first embodiment. The difference is the self-luminous members 25 are formed on the four edges 223 of the front surfaces 222.

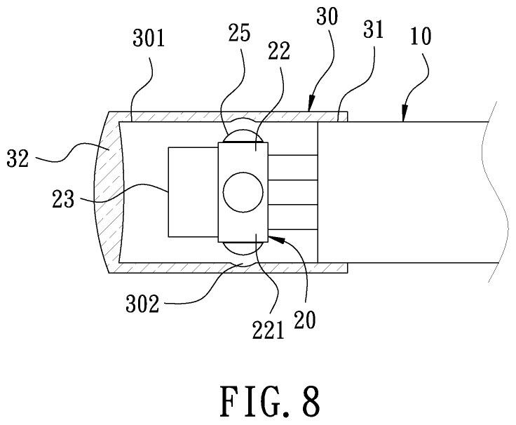

Referring to FIG. 8 which show a sectional view of a third embodiment a miniature endoscope in accordance with the present invention, the structure of the miniature endoscope in this embodiment is substantially the same in structure of the first embodiment. The difference is the front wall 32 of the cover 30 being in a shape of curvature or sphere. This front wall 32 may help the image focus function of the lens 23.

Although the improved miniature endoscope of the present invention has been described in way of preferred embodiment, it is apparent and readily understood that various changes, improvement and modifications can still be made without departing from the spirit of the invention and shall be fallen in the protection scope as the Claims in the present invention.

What is claimed is:

1. A miniature endoscope comprising:
an electric cable;
an image taking device having an optical sensor electrically connected to said electric cable and a lens to capture the image;
a plurality of self-luminous members formed on said image taking device; and
a cover made of optically transparent material and substantially in a tubical shape forming axially an open end secured to said electric cable and a front wall in front of said lens of said image taking device.

2. A miniature endoscope as claimed in claim 1 wherein said self-luminous members can be made of paints with fluorescent coating or phosphorescent coating.

3. A miniature endoscope as claimed in claim 1 wherein said self-luminous members can be organic light emitting diodes.

4. A miniature endoscope as claimed in claim 1 wherein said optical sensor is substantially in a rectangular shape having a front surface and four side surfaces forming into four edges, said lens being formed on the said front surface to capture the image.

5. A miniature endoscope as claimed in claim 4 wherein said self-luminous members are formed on said side surfaces of said optical sensor.

6. A miniature endoscope as claimed in claim 4 wherein said self-luminous members are formed on said edges of said optical sensor.

7. A miniature endoscope as claimed in claim 5 wherein said self-luminous members are in a convex shape.

8. A miniature endoscope as claimed in claim 7 wherein said cover is formed on the inner surface thereof with a plurality of convex recess corresponding and adjacent to said self-luminous members.

9. A miniature endoscope as claimed in claim 1 wherein said front wall of said cover is substantially perpendicular to the axial of said cover.

10. A miniature endoscope as claimed in claim 1 wherein said front wall of said cover is in the shape of a curvature or sphere.
